(19) United States
(12) Patent Application Publication
(10) Pub. No.: US 2007/0194861 A1
(43) Pub. Date: Aug. 23, 2007

(54) Method of transforming impedance and coplanar multi-layer impedance transformer

(76) Inventors: Lluis Jofre Roca, Barcelona (ES); Raquel Serrano Calvo, Barcelona (ES); Sebastian Blanch Boris, Barcelona (ES); Josep Ignasi Cairo Molins, Barcelona (ES)

Correspondence Address: HARNESS, DICKEY & PIERCE, P.L.C., P.O. BOX 828, BLOOMFIELD HILLS, MI, 48303, US

(21) Appl. No.: 11/647,514

(22) Filed: Dec. 28, 2006

(30) Foreign Application Priority Data
Dec. 30, 2005 (EP) 05078048.5

(51) Int. Cl. H01P 5/02

(52) U.S. Cl. 333/33

(57) ABSTRACT

Method of transforming impedance in a structure, said structure comprising a coplanar line between a lower ground plate and an upper active plate, the method comprising: providing N−1 substantially parallel conducting layers, being N>2, inside the ground plate and the upper active plate of the structure, thereby having N coplanar lines, injecting a current in a single first input layer, being said single first input layer the layer above the ground plate, and
using said N coplanar lines as output, whereby at the output the voltage is divided by N, and the current is multiplied by N, being the impedance multiplied by N². The invention also relates to a coplanar multi-layer impedance transformer.

### FIELD OF THE INVENTION

The invention relates to high frequency electromagnetic circuits (transmission lines, filters, antennas) fabricated using different transmission line methodologies as microstrip, stripline or waveguide lines made on planar or quasiplanar substrates. The invention more particularly relates to impedance transforming therein.

The general application fields of the invention are digital communications, particularly wireless/mobile digital communications.

### BACKGROUND OF THE INVENTION

As a general rule, printed circuits are formed by two parallel plates: a lower plate, usually working as the ground plane, and an upper plate, in which the different passive elements (filters, transmission lines, printed antennas, etc.) and active electronic devices are configured.

Most of the current mechanisms for impedance transforming in said printed circuits, consist in the progressive modification of their geometric characteristics. It should be noted that impedance transforming as indicated here is applies to structures working at microwave frequencies or very high frequencies where the size of structures is in order of effective wave length. At lower frequencies there is the typical coil transformer. So far, these changes in geometry are carried out in the upper or active plate, thereby requiring an increase in the “horizontal” dimensions (width and length) of the circuit—as shown in FIG. 1—, these changes being approximately fractions of the wavelength. This size increase, which ends up being in the order of the wave's dimension, is incompatible with miniaturisation, which requires much lower final dimensions. Thus, some impedance transforming without size increase is required.

That is, in general, all geometries get optimal behaviour with resonant lengths that are around λ/2 (λ/4 in some cases where metallic planes are used). But when we look at mobile wireless communication systems, the initial resonant size λ/2 (λ/4) is prohibitive due to the size restriction imposed by the compactness of the devices to which these printed circuits are supposed to be made for.

A large number of downsizing solutions can be found in literature. Some of the techniques applied in order to reduce size, for example, in the case of an antenna, are: shortening and folding the patch, slots and slits on the radiating patch, surface etching, different arrangements of shorting walls or pins, or utilising high dielectric constant materials. All these modifications allow in one way or another for a reduction on the overall size in general at the cost of bandwidth, efficiency or gain reductions. For example, the longitudinal dimension can be halved using a shorting wall in one of the ends of the structure, at the cost of halving the bandwidth. That is, it is difficult to obtain good electrical performance (bandwidth, efficiency, gain) when reducing size.

### SUMMARY OF THE INVENTION

The main objective of the present invention is to achieve impedance transforming without size increase. The point is, given a particular circuit (transmission line, filter, antenna, etc) that has to be connected between quite different input and output impedances, to obtain a good matching using the transformation effect created by a multi-layer structure.

With respect to the stated background, this invention permits the transformation of impedances without increasing the size of the printed circuit, and therefore permits to allocate high frequency electronic circuits (transmission lines, filters, antennas) in very small dimensions.

The present invention discloses a new method that allows to implement an impedance transformer inside a structure which originally consist of two parallel plates.

The invention refers to a method of transforming impedance according to claim 1 and to a coplanar multi-layer transformer method according to claim 4. Preferred embodiments of the method and transformer are defined in the dependent claims.

A first aspect of the invention relates to a method of transforming impedance in a structure, said structure comprising a coplanar line between a lower ground plate and an upper active plate, the method comprising:

providing N−1 substantially parallel conducting layers, being N≧2, inside the ground plate and the upper active plate of the structure, thereby having N coplanar lines,

injecting a current in a single first input layer, being said single first input layer the layer above the ground plate, and

using said N coplanar lines as output, whereby at the output the voltage is divided by N, and the current is multiplied by N, being the impedance multiplied by N².

The method of transforming impedance of the present invention may be used for structures like antennas, filters or transmission lines. The present idea of impedance transformation may also be applicable to other high frequencies devices where an impedance transformation is needed.

Therefore, according to the method of the present invention, the space between the upper active plate and the lower ground plate is used to carry out the impedance transformation. Where traditionally an impedance transformation was carried out by modifying length and width in the horizontal plane, now the thickness of the printed circuit is used to perform said transformation, without a need for increasing the size of the printed circuit.

In the specific case of antennas, the present invention is particularly applicable, as antennas nowadays have to be another element forming part of the integrated circuit, which at present are directed to electronic devices requiring each time smaller dimensions. In such case of antennas, the method preferably further comprises:

providing a radiating slot fed by the N coplanar lines, being the height of each one of the lines of h/N, where h is the height of the radiating slot.

A second aspect of the present invention relates to a coplanar multi-layer impedance transformer in a structure, said structure comprising a coplanar line between a lower ground plate and an upper active plate, the coplanar multi-layer transformer comprising:

N−1 substantially parallel conducting layers, being N≧2, inside the ground plate and the upper active plate of the structure, thereby having N coplanar lines,

injecting means for injecting current in a single first input layer, being said single first input layer the layer above the ground plate, and

output means constituted by said N coplanar lines, whereby at the output the voltage is divided by N, and the current is multiplied by N, being the impedance multiplied by N².

The resulting multi-layer structure which originally consisted of two-plates may be an antenna, a filter or a transmission line.

When the structure is an antenna, said antenna preferably further comprises:

a radiating slot fed by the N coplanar lines, being the height of each one of the lines of h/N, that is, of the order of λ/1000, where h is the height of the radiating slot.

Because of integration technologies, it is possible to have several metallic planes in a very small thickness. The innovation resides in using the multi-layer integration technology in order to construct circuit elements such as filters, transmission lines or printed antennas with a high impedance transforming ration (from low to high impedance and vice-versa).

### SHORT DESCRIPTION OF THE DRAWINGS

A series of drawings aiding to better understand the invention and which are expressly related to a preferred embodiment of said invention, representing a non-limiting example thereof, is very briefly described below.

FIG. 1 shows prior-art impedance transforming (Z₁ to Z₂) in the active layer.

FIG. 2 shows a diagrammatic representation of the impedance transforming effect for the multi-layer structure of the present invention.

FIG. 3 shows the voltage/current (V, I) relation at the input and output ports of the multi-layer transformer of the present invention.

FIG. 4 shows a schematic layout of a prior-art patch-antenna.

FIG. 5 schematically shows the radiation of a patch-antenna.

FIGS. 6a and 6b show the radiating slots for a two-plate structure and a multi-layer structure.

FIG. 7 shows a 3-dimensional view of a λ/2 coplanar multi-layer transformer patch-antenna.

FIG. 8 shows a possible configuration for the coplanar multi-layer transformer patch-antenna of the invention.

FIG. 9 again shows a coplanar multi-layer transformer antenna.

### DESCRIPTION OF PREFERRED EMBODIMENTS OF THE INVENTION

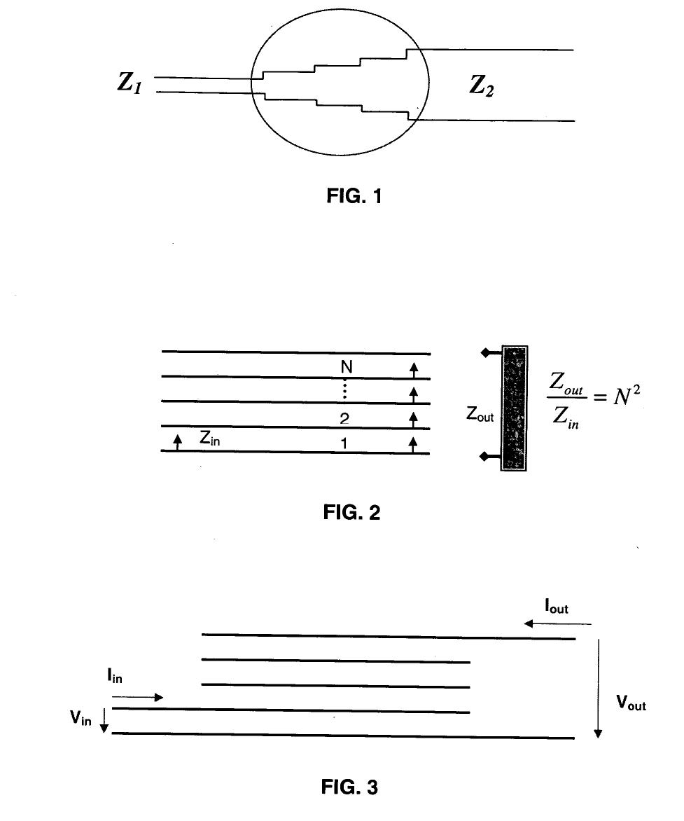

As indicated before, FIG. 1 shows how impedance transforming could be achieved in the prior-art structures, by increasing the size of the active plate.

FIG. 2 shows diagrammatically how impedance transforming is carried out with the 1 to N coplanar multi-layer transformer of the present invention, which gives a 1:N² impedance transformation ratio.

This is also shown in FIG. 3: at the output the voltage Vₒᵤₜ is divided by N, and the current Iₒᵤₜ is multiplied by N, being the impedance multiplied by N².

This way, an impedance transformation is achieved between input and output, without increasing neither the horizontal nor the vertical dimensions, of the circuit.

As indicated before, current electronic applications require devices of ever smaller dimensions with an ever increasing level of integration. Therefore, antennas has to be another element of the integrated device. Thus, the antenna has to be adapted to the miniaturisation requirements, both in the horizontal and vertical dimensions, of the present-day integrated circuits. This leads to horizontal dimensions being in the order of ten millimetres, while the vertical dimension is more constrained by the present-day integration technologies, which are below the millimetre,

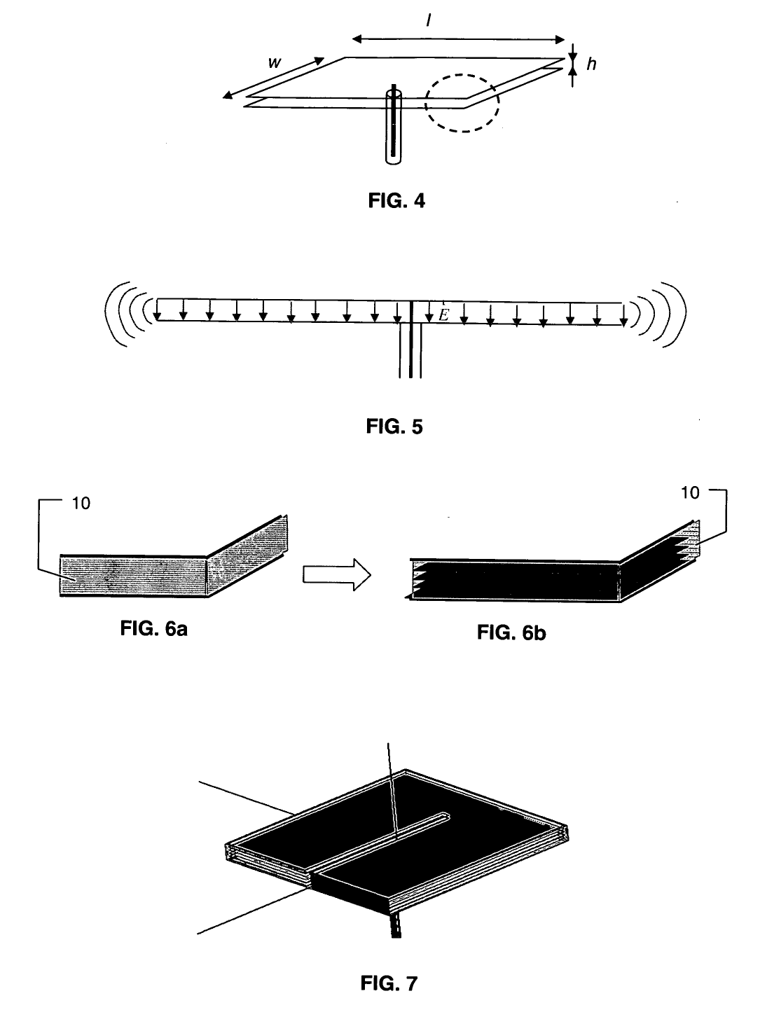

In the specific case of patch-based antennas, a diagrammatic layout of which is shown in FIG. 4, they have a very flat geometry.

As a result of this, patch-based antennas have a very low impedance characteristic as transmission line:

$${Z}_{c} = \frac{377}{\sqrt{{ɛ}_{reff}}} \frac{h}{{w}_{e}} ,$$

where h is the thickness, ε_{reff} is the dielectric constant of the dielectric material, and we can be approached in this case by w (line width); and they have a very high impedance characteristic as a radiating element. For thickness h much smaller than λ, the radiating resistance will approximately be:

$$R \approx 120 \frac{λ}{w}$$

and having a width of w˜0.25λ, that resistance gets to values around 500Ω.

So, the smaller the radiating slot is, the higher the radiating impedance Z is. For 1 mm high slots, the impedance will be of the order of hundreds of ohms. The problem arising then is how to match the very low transmission line impedance (around 2-5Ω) to the high radiation impedance (which can be as high as 300-500Ω).

Thus, the method of transforming impedance of the present invention is particularly appropriate for integrated antennas, as an impedance transforming effect of N² can be obtained.

Patch-antennas are formed by a radiating structure of parallel metallic planes or layers. This type of RF structures are fed by a transmission line (the coaxial wire in FIGS. 4 and 5), and they basically behave as an electromagnetic resonant cavity with an electric and magnetic field distribution between the two conducting layers: the lower or ground plate and the upper or active layer. The radiation of this kind of structures can be interpreted as the one produced by the distribution of the electric and magnetic fields existing in the edges of the cavity (vertical walls of the cavity). The radiation of a patch-antenna is schematically shown in FIG. 5.

While the impedance of the fields in the interior of the cavity (impedance as transmission line) is very low, the impedance of the slot expressed in circuit terms is very high. If this structure is made to radiate, being its height h very small, the difference between both impedances (in transmission and radiating modes) will be even higher, and the matching between them would be very difficult.

FIGS. 6a and 6b show how in an RF structure (patch-antenna) which is 1 mm thick (that is, with 1 mm high radiating slots) N layers are introduced, these N layers being separated by a distance d which is in the order of a thousandth of the wavelength (d<<λ).

In both the structures shown in FIG. 6a as in FIG. 6b the radiating slots 10 are exactly the same, that is, they have the same dimensions (l×w×h). The radiating slot 10 of the structure of FIG. 6b is fed by the N coplanar lines, the height of which is h/N.

FIGS. 7-9 refer to a specific preferred embodiment of the present invention, which is a coplanar multi-layer transformer antenna.

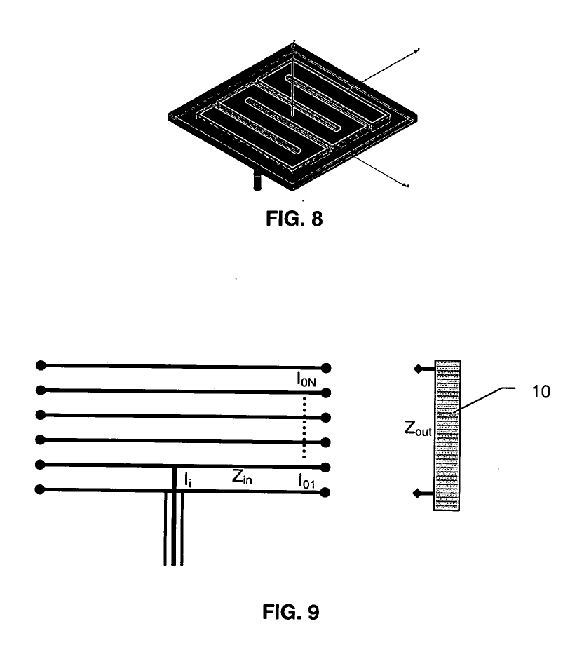

As shown in FIG. 9, the coplanar multi-layer impedance transformer comprises a set of N layered wave-guiding structures (conductor and dielectric structures) connecting a low impedance Zᵢₙ point to a high radiating structure with impedance Zₒᵤₜ (=N²Z₀) through the N² transforming relation.

As indicated before, for a 1 mm thick patch-antenna, the characteristic impedance is increased if inside that 1 mm cavity several parallel metallic layers or sheets are introduced.

1. Method of transforming impedance in a structure, said structure comprising a coplanar line between a lower ground plate and an upper active plate, the method comprising:
providing N−1 substantially parallel conducting layers, being N≧2, inside the ground plate and the upper active plate of the structure, thereby having N coplanar lines,
injecting a current in a single first input layer, being said single first input layer the layer above the ground plate, and
using said N coplanar lines as output, whereby at the output the voltage is divided by N, and the current is multiplied by N, being the impedance multiplied by N².

2. Method of transforming impedance according to claim 1, wherein said structure is an antenna.

3. Method of transforming impedance according to claim 2, wherein the method further comprises:
providing a radiating slot fed by the N coplanar lines, being the height of each one of the lines of h/N, where h is the height of the radiating slot.

4. A coplanar multi-layer impedance transformer in a structure, said structure comprising a coplanar line between a lower ground plate and an upper active plate, the coplanar multi-layer transformer comprising,
N−1 substantially parallel conducting layers, being N≧2 inside the ground plate and the upper active plate of the structure, thereby having N coplanar lines,
injecting means for injecting current in a single first input layer, being said single first input layer the layer above the ground plate, and
output means constituted by said N coplanar lines, whereby at the output the voltage is divided by N, and the current is multiplied by N, being the impedance multiplied by N².

5. Coplanar multi-layer impedance transformer according to claim 4, wherein said structure is an antenna.

6. Coplanar multi-layer impedance transformer according to claim 5, wherein said antenna further comprises:
a radiating slot fed by the N coplanar lines, being the height of each one of the lines of h/N, where h is the height of the radiating slot.

7. Coplanar multi-layer impedance transformer according to claim 4, wherein said structure is a transmission line.

8. Coplanar multi-layer impedance transformer according to claim 4, wherein said structure is a filter.
